(19) United States
(12) Patent Application Publication
(10) Pub. No.: US 2023/0322499 A1
(43) Pub. Date: Oct. 12, 2023

(54) DEVICE AND METHOD FOR SEPARATING MATERIALS

(71) Applicant: ABB Schweiz AG, Baden (CH)

(72) Inventors: Haoteng Lei, Shanghai (CN); Lei Zhuang, Shanghai (CN); Jianwei Liu, Shanghai (CN); Dilong Yu, Shanghai (CN)

(21) Appl. No.: 18/042,203

(22) PCT Filed: Aug. 24, 2020
(86) PCT No.: PCT/CN2020/110867

§ 371 Date: Feb. 17, 2023

(51) Int. Cl. B65G 47/28; B65G 27/04; B65G 27/12

(52) U.S. Cl. CPC B65G 47/28; B65G 27/04; B65G 27/12; B65G 2201/0202; B65G 2201/047

(57) ABSTRACT

A device and a method for separating materials. The device includes a material receiving plate arranged to receive materials to be separated, a first pair of supporting members coupled to opposite sides of the material receiving plate via respective pendulum rods, and a second pair of supporting members coupled to the opposite sides of the material receiving plate via respective pendulum rods and spaced apart from the first pair of supporting members. The device also includes a driving mechanism and a transmission mechanism.

### FIELD

Embodiments of present disclosure generally relate to the field of material separating, and more particularly, to a device and a method for separating materials.

### BACKGROUND

In the field of food processing, strip materials, such as sausages, spicy strips, instant noodle forks and the like, are typically conveyed by a conveyor and picked up by a robot arm during the conveying for further processing. However, since the incoming materials are often placed in a box or a basket in a disordered state, it is necessary to separate the stacked or crossed materials before placing them onto the conveyor. In the current market, the separating of the materials is a challenge for food manufacturers.

Vibrator bowls are conventionally utilized to separate the strip materials (especially the instant noodle forks) in the disordered state. However, such a material separating mechanism has many drawbacks and is hard to meet the needs of automatic production. For example, the material separating speed of the vibrator bowl is relatively slow. In order to meet the actual production requirements, 4-5 vibrator bowls are usually required to operate at the same time. In addition, the adaptability of the vibrator bowl is poor. When a different type of material is to be separated, a disc of the vibrator bowl would usually need to be replaced. Since the disk of the vibrator bowl is typically heavy, it would take much time and effort to replace the disk. Further, the materials to be separated sometimes may get stuck in the vibrator bowl, which would require manual intervention of an operator and thus adversely affect the production efficiency. Moreover, the vibrator bowl also has the disadvantages of large area and high noise.

Thus, there is need for a solution for separating the materials which could better meet the needs of automatic production.

### SUMMARY

In view of the foregoing problems, various example embodiments of the present disclosure provide a device and a method for separating materials so as to improve the efficiency and adaptability of the material separating.

In a first aspect of the present disclosure, example embodiments of the present disclosure provide a device for separating materials. The device comprises a material receiving plate arranged to receive materials to be separated; a first pair of supporting members coupled to opposite sides of the material receiving plate via respective pendulum rods; a second pair of supporting members coupled to the opposite sides of the material receiving plate via respective pendulum rods and spaced apart from the first pair of supporting members; a driving mechanism comprising a rotatable output shaft; and a transmission mechanism arranged between the output shaft and the material receiving plate. The transmission mechanism comprises a cam arranged on the output shaft and being rotatable along with the output shaft; a connecting seat arranged on the material receiving plate; and a connecting rod coupled to the cam at a first end thereof and coupled to the connecting seat at a second end thereof opposite to the first end.

In some embodiments, the driving mechanism comprises a motor; and a reducer coupled to the motor, wherein the output shaft is arranged on the reducer.

In some embodiments, the output shaft is provided with a protrusion at its periphery, and the cam comprises a first mounting hole for insertion of the output shaft and a recess for cooperation with the protrusion at an internal wall of the first mounting hole.

In some embodiments, the connecting rod comprises a first main part; a first pin shaft arranged on the first main part via a hinge at the first end of the connecting rod, the first pin shaft being coupled to the cam; and a second pin shaft arranged on the first main part via a hinge at the second end of the connecting rod, the second pin shaft being coupled to the connecting seat.

In some embodiments, the cam comprises a second mounting hole at a distance from the output shaft, and the first pin shaft is inserted into to the second mounting hole.

In some embodiments, the material receiving plate comprises a sieve plate having a top side configured to receive the materials to be separated and a bottom side opposite to the top side; a first mounting plate arranged at the bottom side of the sieve plate and coupled to the first pair of supporting members via the respective pendulum rods; and a second mounting plate arranged at the bottom side of the sieve plate at a distance from the first mounting plate and coupled to the second pair of supporting members via the respective pendulum rods.

In some embodiments, the sieve plate comprises a plurality of ribs arranged in parallel at the top side of the sieve plate.

In some embodiments, each of the first and second mounting plates comprises a supporting part coupled to the bottom side of the sieve plate to support the sieve plate; and a pair of mounting parts arranged at both ends of the supporting part respectively and coupled to the respective pair of the supporting members via the respective pendulum rods.

In some embodiments, the connecting seat is arranged on the supporting part of the first mounting plate.

In some embodiments, the height of the second pair of supporting members is lower than the height of the first pair of supporting members such that the material receiving plate is tilted.

In some embodiments, each of the pendulum rods comprises a second main part; a third pin shaft arranged on the second main part via a hinge at an end of the second main part, the third pin shaft being coupled to the respective one of the first pair of supporting members and the second pair of supporting members; and a fourth pin shaft arranged on the second main part via a hinge at the other end of the second main part, the fourth pin shaft being coupled to the material receiving plate.

In a second aspect of the present disclosure, example embodiments of the present disclosure provide a method of separating materials using the device according to the first aspect of the present disclosure. The method comprises receiving the materials to be separated on the material receiving plate; and causing the output shaft of the driving mechanism to rotate to drive the material receiving plate to move upwards and downwards and forwards and backwards via the transmission mechanism so as to separate the materials on the material receiving plate.

According to various embodiments of the present disclosure, the cam may rotate along with the output shaft of the driving mechanism and thus drive the connecting rod to realize continuous reciprocating motion. Then, the connecting rod would drive the material receiving plate to move upwards and downwards and forwards and backwards repeatedly. In this way, the materials placed onto the material receiving plate may be substantially separated from each other.

Comparing with the conventional vibrator bowl, the separating device according to embodiments of the present disclosure would have a higher material separating speed due to the up-and-down and back-and-fourth motion of the material receiving plate, meeting the needs of automatic production.

Moreover, the separating device according to embodiments of the present disclosure has good adaptability for different types of materials. That is, the separating device may be used to separate different types of materials.

In addition, during the material separating process, the materials may be sufficiently separated on the material receiving plate and delivered to a next stage. Thus, there is no risk of materials being stuck.

Furthermore, comparing with the conventional vibrator bowl, the separating device according to embodiments of the present disclosure has smaller area and lower noise.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 illustrates a perspective view of a device for separating materials in accordance with an embodiment of the present disclosure viewed in a direction;

FIG. 2 illustrates a perspective view of the device as shown in FIG. 1 viewed in another direction;

FIG. 3 illustrates a perspective view of a driving mechanism in accordance with an embodiment of the present disclosure;

FIG. 4 illustrates a perspective view of a cam in accordance with an embodiment of the present disclosure;

FIG. 5 illustrates a perspective view of a connecting rod in accordance with an embodiment of the present disclosure;

FIG. 6 illustrates a perspective view of a connecting seat in accordance with an embodiment of the present disclosure;

FIG. 7 illustrates a perspective view of a material receiving plate in accordance with an embodiment of the present disclosure;

FIG. 8 illustrates a perspective view of a pendulum rod in accordance with an embodiment of the present disclosure;

FIG. 9 illustrates a moving direction of the materials separated by the material receiving plate in a front view of the device as shown in FIG. 1; and

FIG. 10 illustrates the moving direction of the materials separated by the material receiving plate in a top view of the device as shown in FIG. 1.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

As discussed above, the material separating speed of the conventional vibrator bowl is relatively slow. According to embodiments of the present disclosure, to improve the material separating efficiency, the transmission mechanism with a specific configuration is provided between the driving mechanism and the material receiving plate so as to drive the material receiving plate to move upwards and downwards and forwards and backwards. The above idea may be implemented in various manners, as will be described in detail in the following paragraphs.

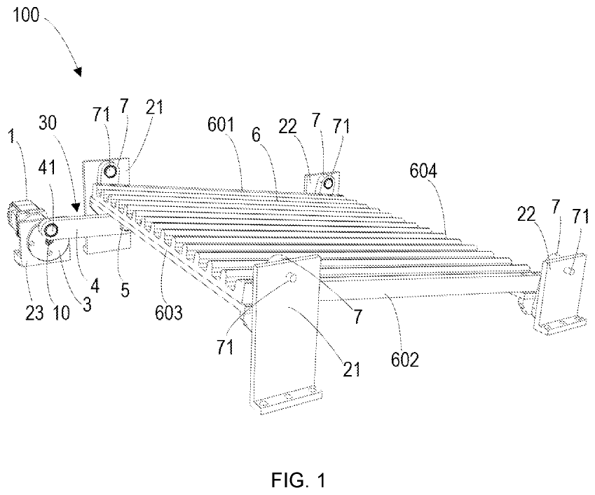

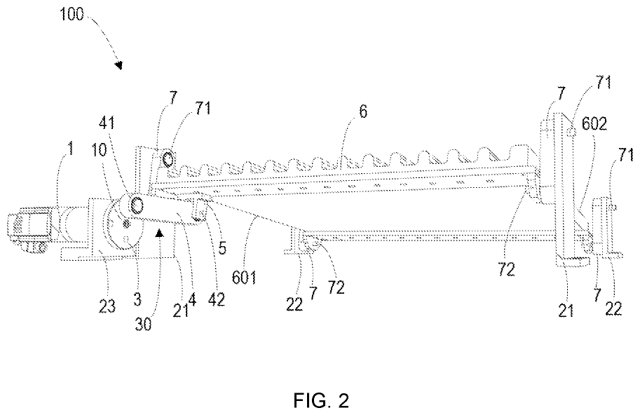

Hereinafter, the principles of the present disclosure will be described in detail with reference to FIGS. 1-10. Referring to FIGS. 1 and 2 first, FIG. 1 illustrates a perspective view of a device 100 for separating materials in accordance with an embodiment of the present disclosure viewed in a direction, and FIG. 2 illustrates a perspective view of the device 100 as shown in FIG. 1 viewed in a different direction. As shown in FIGS. 1 and 2, the device 100 described herein generally includes a material receiving plate 6, a first pair of supporting members 21, a second pair of supporting members 22, a driving mechanism 1, and a transmission mechanism 30. The material receiving plate 6 is arranged to receive materials to be separated at its upper surface. The supporting members 21 and 22 are arranged to support the material receiving plate 6 via respective pendulum rods 7. The transmission mechanism 30 is arranged between the driving mechanism 1 and the material receiving plate 6 so as to transfer motion from the driving mechanism 1 to the material receiving plate 6.

In an embodiment, as shown in FIGS. 1 and 2, the material receiving plate 6 is generally of rectangular shape and includes first, second, third, and fourth sides 601, 602, 603, 604. The first side 601 is opposite to the second side 602, and the third side 603 is opposite to the fourth side 604. During the material separating process, the materials to be separated may be placed onto the upper surface of the material receiving plate 6 via a centrifuge, an elevator, or other material supply devices.

The supporting members 21 and 22 may be arranged on a working table, on the ground, or at various other sites. One of the first pair of supporting members 21 is coupled to the first side 601 of the material receiving plate 6 via the respective pendulum rod 7, and the other one of the first pair of supporting members 21 is coupled to the second side 602 of the material receiving plate 6 via the respective pendulum rod 7. Likewise, one of the second pair of supporting members 22 is coupled to the first side 601 of the material receiving plate 6 via the respective pendulum rod 7, and the other one of the second pair of supporting members 22 is coupled to the second side 602 of the material receiving plate 6 via the respective pendulum rod 7. The second pair of supporting members 22 is spaced apart from the first pair of supporting members 21. In other words, the second pair of supporting members 22 is arranged at a different position from the first pair of supporting members 21 along the first and second sides 601, 602 of the material receiving plate 6.

Each of the pendulum rods 7 is coupled to the respective one of the supporting members 21 and 22 at an end and coupled to the material receiving plate 6 at the other end. With such an arrangement, the material receiving plate 6 is capable of swinging with respect to the supporting members 21 and 22 upon being driven by the driving mechanism 1 via the transmission mechanism 30.

As shown in FIGS. 1 and 2, the driving mechanism 1 is arranged on a third supporting member 23 and includes a rotatable output shaft 10. When the driving mechanism 1 is powered on, the output shaft 10 would rotate along a predetermined direction. The transmission mechanism 30 is arranged between the output shaft 10 of the driving mechanism 1 and the material receiving plate 6 so as to drive the material receiving plate 6 when the driving mechanism 1 operates.

The transmission mechanism 30 includes a cam 3, a connecting seat 5, and a connecting rod 4. The cam 3 is arranged on the output shaft 10 and may rotate along with the output shaft 10. The connecting seat 5 is arranged on the material receiving plate 6. The connecting rod 4 is coupled to the cam 3 at a first end thereof and coupled to the connecting seat 5 at a second end thereof opposite to the first end, so as to transfer motion from the driving mechanism 1 to the material receiving plate 6. With such an arrangement, the cam 3 may rotate along with the output shaft 10 of the driving mechanism 1 and thus drive the connecting rod 4 to realize continuous reciprocating motion. Then, the connecting rod 4 would drive the material receiving plate 6 to swing with respect to the supporting members 21 and 22, i.e., to move upwards and downwards and forwards and backwards repeatedly. In this way, the materials placed onto the material receiving plate 6 may be separated from each other efficiently, meeting the needs of automatic production.

In an embodiment, as shown in FIGS. 1 and 2, the height of the second pair of supporting members 22 is lower than the height of the first pair of supporting members 21 such that the material receiving plate 6 is tilted from the third side 603 to the fourth side 604. With such an arrangement, the materials to be separated may be placed onto the upper surface of the material receiving plate 6 near to the third side 603 of the material receiving plate 6. As the material receiving plate 6 moves upwards and downwards and forwards and backwards repeatedly, the materials may move towards the fourth side 604 of the material receiving plate 6 and may be delivered to a next stage, such as a conveyor.

It is to be understood that the relationship between the heights of the supporting members 21 and 22 as shown in FIGS. 1 and 2 is only used as an example, but is not intended to limit the scope of the present application. In some embodiments, the heights of the supporting members 21 and 22 may have other relationships. For example, the heights of the supporting members 21 and 22 may be generally equal to each other, or the height of the supporting members 21 may be lower than the height of the supporting members 22.

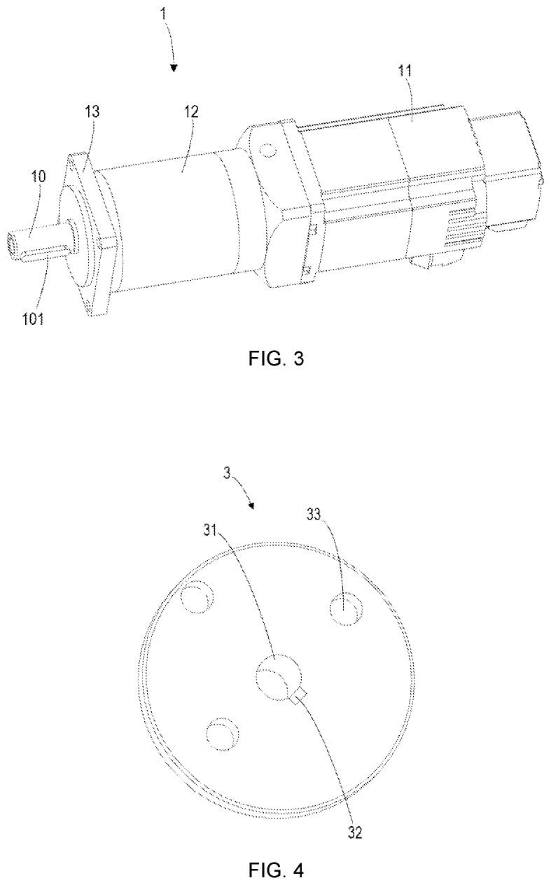

FIG. 3 illustrates an example construction of the driving mechanism 1. As shown, the driving mechanism 1 includes a motor 11 and a reducer 12 coupled to the motor 11. The output shaft 10 is arranged on the reducer 12. The reducer 12 is provided with a flange 13 adapted to be mounted onto the third supporting member 23 as shown in FIGS. 1 and 2. With such an arrangement, when the motor 11 is powered on, the reducer 12 may drive the output shaft 10 to rotate at a desired speed. It is to be understood that the construction of the driving mechanism 1 as shown in FIG. 3 is only used as an example, but is not intended to limit the scope of the present application.

In some embodiments, as shown in FIG. 3, the output shaft 10 is provided with a protrusion 101 at its periphery. The protrusion 101 substantially extends along a length direction of the output shaft 10. Accordingly, as shown in FIG. 4, the cam 3 includes a first mounting hole 31 for insertion of the output shaft 10 and a recess 32 for cooperation with the protrusion 101. The recess 32 is formed at an internal wall of the first mounting hole 31. With such an arrangement, when the output shaft 10 is inserted into the first mounting hole 31, the protrusion 101 may be positioned inside the recess 32 such that the cam 3 and the output shaft 10 rotate simultaneously. In other embodiments, the cam 3 may be mounted onto the output shaft 10 in other manners. The scope of the present application is not intended to be limited in this respect.

In an embodiment, as shown in FIG. 4, the cam 3 further includes a second mounting hole 33 at a distance from the first mounting hole 31. The second mounting hole 33 is to be coupled to the connecting rod 4, which will be described hereinafter in conjunction with FIGS. 1-2 and 5.

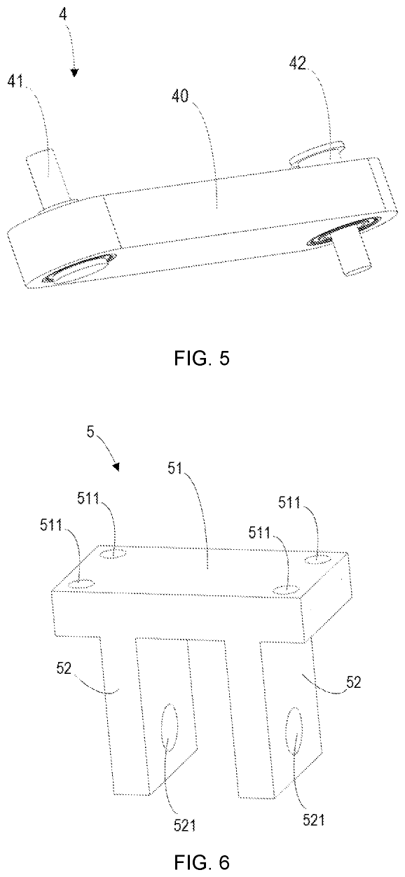

FIG. 5 illustrates an example construction of the connecting rod 4. As shown in FIGS. 1-2 and 5, the connecting rod 4 includes a first main part 40, a first pin shaft 41, and a second pin shaft 42. The first pin shaft 41 is arranged on the first main part 40 via a hinge (not shown) at the first end of the connecting rod 4. The second pin shaft 42 is arranged on the first main part 40 via a hinge (not shown) at the second end of the connecting rod 4. The first pin shaft 41 is suitable for being coupled to the cam 3. For example, the first pin shaft 41 may be inserted into the second mounting hole 33 and fixedly coupled to the cam 3. The second pin shaft 42 is suitable for being coupled to the connecting seat 5. With such an arrangement, when the output shaft 10 of the driving mechanism 1 drives the cam 3 to rotate, the cam 3 would drive the connecting rod 4 to realize continuous reciprocating motion. In the meanwhile, the first and second pin shafts 41, 42 would rotate with respect to the first main part 40.

It is to be understood that the construction of the connecting rod 4 as shown in FIG. 5 is only used as an example, but is not intended to limit the scope of the present application. For example, in some embodiments, the first and second pin shafts 41, 42 may be fixedly mounted on the first main part 40. Accordingly, the first pin shaft 41 may rotate with respect to the cam 3, and the second pin shaft 42 may rotate with respect to the connecting seat 5. With such an arrangement, the motion transferring between the driving mechanism 1 and the material receiving plate 6 may also be achieved via the connecting rod 4.

FIG. 6 illustrates an example construction of the connecting seat 5. As shown, the connecting seat 5 includes a base part 51 and a pair of connecting parts 52. The connecting parts 52 are arranged in parallel on the base part 51. The base part 51 is provided with third mounting holes 511 suitable for mounting the connecting seat 5 onto the material receiving plate 6 through fasteners, such as screws. Each of the connecting parts 52 is provided with a fourth mounting hole 521 suitable for being coupled to the second pin shaft 42 of the connecting rod 4. It is to be understood that the construction of the connecting seat 5 as shown in FIG. 6 is only used as an example, but is not intended to limit the scope of the present application. The connecting seat 5 may have various constructions.

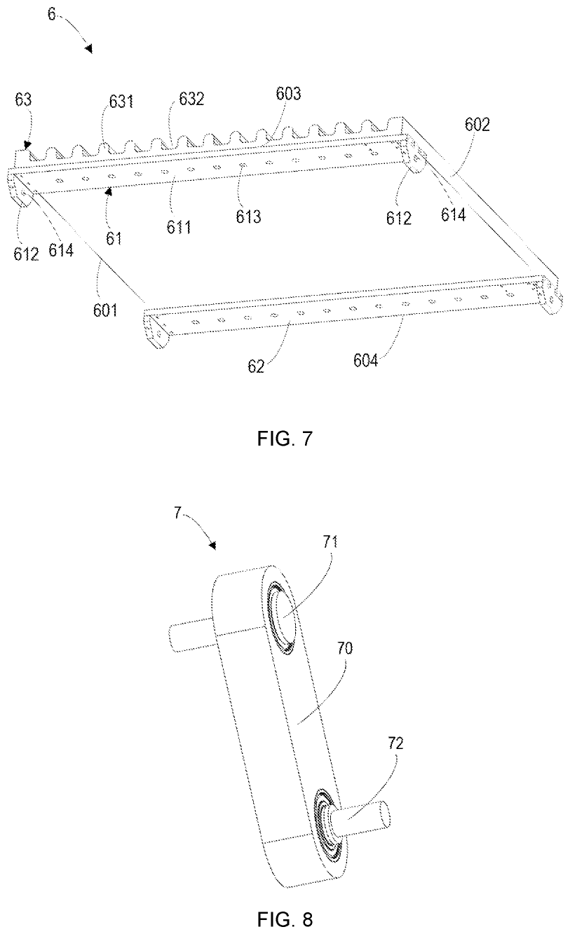

FIG. 7 illustrates an example construction of the material receiving plate 6. In an embodiment, as shown in FIG. 7, the material receiving plate 6 includes a sieve plate 63, a first mounting plate 61, and a second mounting plate 62.

As shown in FIG. 7, the sieve plate 63 has a top side configured to receive the materials to be separated and a bottom side opposite to the top side. A plurality of ribs 631 are provided in parallel at the top side of the sieve plate 63. Each of the ribs 631 extends from the third side 603 to the fourth side 604 of the material receiving plate 6. Accordingly, a plurality of grooves 632 are provided between the ribs 631. With such an arrangement, when the material receiving plate 6 move upwards and downwards and forwards and backwards repeatedly under driving of the driving mechanism 1, the materials, especially strip materials, on the top side of the sieve plate 63 may be separated by the ribs 631 and the grooves 632 efficiently.

As shown in FIG. 7, the sieve plate 63 is supported by the first and second mounting plates 61, 62. The first mounting plate 61 is arranged at the bottom side of the sieve plate 63. The first mounting plate 61 is suitable for being coupled to the first pair of supporting members 21 via the respective pendulum rods 7. The second mounting plate 62 is also arranged at the bottom side of the sieve plate 63 and spaced apart from the first mounting plate 61. The second mounting plate 62 is suitable for being coupled to the second pair of supporting members 22 via the respective pendulum rods 7.

In some embodiments, as shown in FIG. 7, the first mounting plate 61 includes a supporting part 611 and a pair of mounting parts 612. The supporting part 611 is coupled to the bottom side of the sieve plate 63 to support the sieve plate 63. For example, the supporting part 611 may be provided with fifth mounting holes 613 suitable for coupling the first mounting plate 61 on to the sieve plate 63 through fasteners. The mounting parts 612 are arranged at both ends of the supporting part 611 respectively and suitable for being coupled to the respective pair of the supporting members 21, 22 via the respective pendulum rods 7. For example, each of the mounting parts 612 may be provided with a sixth mounting hole 614 suitable for being coupled to the respective pendulum rod 7.

In an embodiment, as shown in FIGS. 1-2 and 7, the connecting seat 5 is arranged on the supporting part 611 of the first mounting plate 61 near to the first side 601 of the material receiving plate 6. However, this is only an example position, but is not a limitation to the position of the connecting seat 5. In other embodiments, the connecting seat 5 may be arranged near to the middle of the supporting part 611 of the first mounting plate 61, near to the second side 602 of the material receiving plate 6, or at other positions of the material receiving plate 6.

It is to be understood that the construction of the material receiving plate 6 as shown in FIG. 7 is only used as an example, but is not intended to limit the scope of the present application. In other embodiments, the material receiving plate 6 may have other constructions. For example, the material receiving plate 6 may be integrally formed, instead of consisting of several parts.

FIG. 8 illustrates an example construction of the pendulum rod 7. In an embodiments, as shown in FIGS. 1-2 and 8, each of the pendulum rods 7 includes a second main part 70, a third pin shaft 71, and a fourth pin shaft 72. The third pin shaft 71 is arranged on the second main part 70 via a hinge (not shown) at an end of the second main part 70. The fourth pin shaft 72 is arranged on the second main part 70 via a hinge (not shown) at the other end of the second main part 70. The third pin shaft 71 is suitable for being coupled to the respective one of the supporting members 21 and 22. The fourth pin shaft 72 is suitable for being coupled to the material receiving plate 6. For example, the fourth pin shaft 72 may be inserted into the sixth mounting hole 614 of the mounting plates 61 and 62 and fixedly mounted on the material receiving plate 6, as shown in FIGS. 1-2 and 7-8. With such an arrangement, the material receiving plate 6 is capable of swinging with respect to the supporting members 21 and 22 upon being driven by the driving mechanism 1 via the transmission mechanism 30.

It is to be understood that the construction of the pendulum rod 7 as shown in FIG. 8 is only used as an example, but is not intended to limit the scope of the present application. For example, in some embodiments, the third and fourth pin shafts 71, 72 may be fixedly mounted on the second main part 70. Accordingly, the third pin shaft 71 may rotate with respect to the respective one of the supporting members 21 and 22, and the fourth pin shaft 72 may rotate with respect to the material receiving plate 6. With such an arrangement, the swinging of the material receiving plate 6 with respect to the supporting members 21 and 22 may also be achieved.

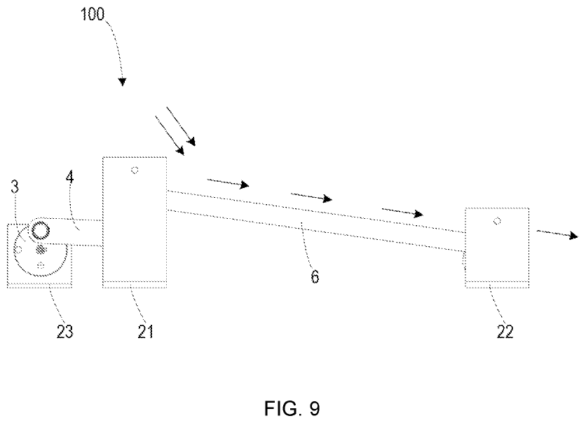

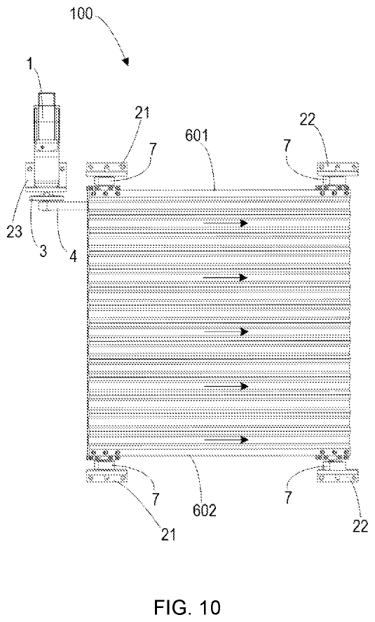

FIGS. 9 and 10 illustrates the moving direction of the materials separated by the material receiving plate 6 in front and top views of the device 100 as shown in FIG. 1, respectively. As shown, the materials to be separated are placed onto the upper surface of the material receiving plate 6 near to first pair of supporting members 21. Since the height of the second pair of supporting members 22 is lower than the height of the first pair of supporting members 21, the materials would move in a direction from the supporting members 21 to the supporting members 22, as indicated by the arrows.

According to various embodiments of the present disclosure, the cam 3 may rotate along with the output shaft 10 of the driving mechanism 1 and thus drive the connecting rod 4 to realize continuous reciprocating motion. Then, the connecting rod 4 would drive the material receiving plate 6 to move upwards and downwards and forwards and backwards repeatedly. In this way, the materials placed onto the material receiving plate 6 may be substantially separated from each other.

Comparing with the conventional vibrator bowl, the separating device 100 would have a higher material separating speed due to the up-and-down and back-and-fourth motion of the material receiving plate 6, meeting the needs of automatic production.

Moreover, the separating device 100 has good adaptability for different types of materials. That is, the separating device 100 may be used to separate different types of materials, such as sausages, spicy strips, instant noodle forks and the like.

In addition, during the material separating process, the materials may be sufficiently separated on the material receiving plate 6 and delivered to a next stage. Thus, there is no risk of materials being stuck.

Furthermore, comparing with the conventional vibrator bowl, the separating device 100 has smaller area and lower noise.

Embodiments of the present disclosure also provides a method for separating materials using the device 100 as described above with reference to FIGS. 1-10. The method includes receiving the materials to be separated on the material receiving plate 6; and causing the output shaft 10 of the driving mechanism 1 to rotate to drive the material receiving plate 6 to move upwards and downwards and forwards and backwards via the transmission mechanism 30 so as to separate the materials on the material receiving plate 6.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A device for separating materials, comprising:
a material receiving plate arranged to receive materials to be separated;
a first pair of supporting members coupled to opposite sides of the material receiving plate via respective pendulum rods;
a second pair of supporting members coupled to the opposite sides of the material receiving plate via respective pendulum rods 474 and spaced apart from the first pair of supporting members;
a driving mechanism comprising a rotatable output shaft; and
a transmission mechanism arranged between the output shaft and the material receiving plate and comprising:
a cam arranged on the output shaft and being rotatable along with the output shaft;
a connecting seat arranged on the material receiving plate; and
a connecting rod coupled to the cam at a first end thereof and coupled to the connecting seat at a second end thereof opposite to the first end.

2. The device according to claim 1, wherein the driving mechanism comprises:
a motor; and
a reducer coupled to the motor, wherein the output shaft is arranged on the reducer.

3. The device according to claim 1, wherein the output shaft is provided with a protrusion at its periphery, and
wherein the cam comprises a first mounting hole for insertion of the output shaft and a recess for cooperation with the protrusion at an internal wall of the first mounting hole.

4. The device according to claim 1, wherein the connecting rod comprises:
a first main part;
a first pin shaft arranged on the first main part via a hinge at the first end of the connecting rod, the first pin shaft being coupled to the cam; and
a second pin shaft arranged on the first main part via a hinge at the second end of the connecting rod, the second pin shaft being coupled to the connecting seat.

5. The device according to claim 4, wherein the cam comprises a second mounting hole at a distance from the output shaft, and
wherein the first pin shaft is inserted into to the second mounting hole.

6. The device according to claim 1, wherein the material receiving plate comprises:
a sieve plate having a top side configured to receive the materials to be separated and a bottom side opposite to the top side;
a first mounting plate arranged at the bottom side of the sieve plate and coupled to the first pair of supporting members via the respective pendulum rods; and
a second mounting plate arranged at the bottom side of the sieve plate at a distance from the first mounting plate and coupled to the second pair of supporting members via the respective pendulum rods.

7. The device according to claim 6, wherein the sieve plate comprises a plurality of ribs arranged in parallel at the top side of the sieve plate.

8. The device according to claim 6, wherein each of the first and second mounting plates comprises:
a supporting part coupled to the bottom side of the sieve plate to support the sieve plate; and
a pair of mounting parts at both ends of the supporting part respectively and coupled to the respective pair of the supporting members via the respective pendulum rods.

9. The device according to claim 8, wherein the connecting seat is arranged on the supporting part of the first mounting plate.

10. The device according to claim 1, wherein the height of the second pair of supporting members is lower than the height of the first pair of supporting members such that the material receiving plate is tilted.

11. The device according to claim 1, wherein each of the pendulum rods comprises:
a second main part;
a third pin shaft arranged on the second main part via a hinge at an end of the second main part, the third pin shaft being coupled to the respective one of the first pair of supporting members and the second pair of supporting members; and
a fourth pin shaft arranged on the second main part via a hinge at the other end of the second main part, the fourth pin shaft being coupled to the material receiving plate.

12. A method for separating materials using the device according to claim 1, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

13. A method for separating materials using the device according to claim 2, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

14. A method for separating materials using the device according to claim 3, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

15. A method for separating materials using the device according to claim 4, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

16. A method for separating materials using the device according to claim 6, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

17. A method for separating materials using the device according to claim 7, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

18. A method for separating materials using the device according to claim 8, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

19. A method for separating materials using the device according to claim 10, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.

20. A method for separating materials using the device according to claim 11, comprising:
receiving the materials to be separated on the material receiving plate; and
causing the output shaft of the driving mechanism to rotate to drive the material receiving plate to move upwards and downwards and forwards and backwards via the transmission mechanism so as to separate the materials on the material receiving plate.
